(19) United States
(12) Patent Application Publication
(10) Pub. No.: US 2025/0207337 A1
(43) Pub. Date: Jun. 26, 2025

(54) GROUND PROCESSING MACHINE

(71) Applicant: Hamm AG, Tirschenreuth (DE)

(72) Inventors: Thomas KLEIN, Mitterteich (DE); Detlef BORNEMANN, Leonberg (DE)

(21) Appl. No.: 18/986,919

(22) Filed: Dec. 19, 2024

(30) Foreign Application Priority Data
Dec. 20, 2023 (DE) DE102023135900.2

(51) Int. Cl. E01C 19/26; F16H 39/00

(52) U.S. Cl. CPC E01C 19/26; F16H 39/00

(57) ABSTRACT

In a ground processing machine having two drive rollers arranged longitudinally and rotatable about a respective axis of rotation, wherein each drive roller comprises two drive roller segments aligned along the direction of the associated axis of rotation, having a hydraulic drive system for the drive rollers, a first fluid connection of a first traction drive hydraulic pump is connected or connectable by means of a first hydraulic line to a first and second traction drive hydraulic motor, and a first fluid connection of a second traction drive hydraulic pump is connected or connectable by means of a second hydraulic line to a third and fourth traction drive hydraulic motor. A second fluid connection of the first pump is connected or connectable by means of a third hydraulic line to the second and third motors, and a second fluid connection of the second pump is connected or connectable by means of a fourth hydraulic line to the first and fourth motors.

The present invention relates to a ground processing machine having two drive rollers arranged one after the other in a machine longitudinal direction and rotatable about a respective axis of rotation, wherein each drive roller comprises two drive roller segments arranged one after the other in the direction of the associated axis of rotation, and having a hydraulic drive system for the drive rollers.

To ensure that torque can continue to be transmitted via other drive roller segments in ground processing machines such as those designed as ground compactors when slippage occurs in one or more of the drive roller segments, it is known to use flow dividers which, when excessive fluid outflow occurs via the hydraulic drive motor associated with such a drive roller segment in a slipping state of a drive roller segment, block or throttle the fluid supply to this drive roller segment and thus maintain a sufficient supply of fluid to the non-slipping drive rollers.

It is the object of the present invention to provide a ground processing machine in which the occurrence of slippage conditions of one or more drive roller segments can be avoided with a structurally simple design of a hydraulic drive system that efficiently uses the energy applied.

According to the invention, this object is achieved by a ground processing machine having two drive rollers arranged one after the other in a machine longitudinal direction and rotatable about a respective axis of rotation, wherein each drive roller comprises two drive roller segments arranged one after the other in the direction of the associated axis of rotation, and having a hydraulic drive system for the drive rollers, wherein the hydraulic drive system comprises:
in association with a first drive roller segment of the two drive rollers, a first traction drive hydraulic motor,
in association with a second drive roller segment of the two drive rollers, a second traction drive hydraulic motor,
in association with a third drive roller segment of the two drive rollers, a third traction drive hydraulic motor,
in association with a fourth drive roller segment of the two drive rollers, a fourth traction drive hydraulic motor,
a first traction drive hydraulic pump,
a second traction drive hydraulic pump,
at least one drive motor for driving the first traction drive hydraulic pump and the second traction drive hydraulic pump for supplying hydraulic fluid to the traction drive hydraulic motors,

wherein:
a first fluid connection of the first traction drive hydraulic pump is connected or connectable by means of a first hydraulic line to a first fluid connection of the first traction drive hydraulic motor and a first fluid connection of the second traction drive hydraulic motor,
a first fluid connection of the second traction drive hydraulic pump is connected or connectable by means of a second hydraulic line to a first fluid connection of the third traction drive hydraulic motor and a first fluid connection of the fourth traction drive hydraulic motor,
a second fluid connection of the first traction drive hydraulic pump is connected or connectable by means of a third hydraulic line to a second fluid connection of the second traction drive hydraulic motor and a second fluid connection of the third traction drive hydraulic motor,
a second fluid connection of the second traction drive hydraulic pump is connected or connectable by means of a fourth hydraulic line to a second fluid connection of the first traction drive hydraulic motor and a second fluid connection of the fourth traction drive hydraulic motor.

In the ground processing machine constructed according to the invention, regardless of the fluid flow direction and thus also regardless of the direction of rotation in which the traction drive hydraulic motors operate, the traction drive hydraulic motors associated with the various drive roller segments are connected crosswise on the outflow side to the two traction drive hydraulic pumps. This means that two traction drive hydraulic motors connected on the inflow side to one of the two traction drive hydraulic pumps are not both connected to this traction drive hydraulic pump on the outflow side. One of the two traction drive hydraulic motors connected to the same traction drive hydraulic pump on the inflow side is connected on the outflow side together with another one of the traction drive hydraulic motors to the other traction drive hydraulic pump.

The result of this is that, if slippage occurs in one of the drive roller segments, a larger amount of fluid is prevented from flowing out via the drive hydraulic motor associated with this drive roller segment by the fact that the drive hydraulic pump connected to the outflow side of this traction drive hydraulic motor only takes up a quantity of fluid defined by its rotational speed, even in the slip state, and therefore the amount of fluid flowing out via the traction drive hydraulic motor of a slipping drive roller segment is substantially limited by the amount of fluid delivered by the traction drive hydraulic motor connected to the same drive hydraulic pump on the outflow side together with this traction drive hydraulic motor.

Excessive outflow of fluid via a traction drive hydraulic motor associated with a slipping drive roller segment is prevented due to this cross-outflow connection of the traction drive hydraulic motors with the traction drive hydraulic pumps without the need to provide a flow divider. This leads to a structurally significantly simpler design of the hydraulic drive system and, due to the fact that flow dividers generally lead to energy losses, a more efficient use of the energy provided to drive the traction drive hydraulic pumps. This is particularly advantageous in electro-hydraulic drive systems in which the traction drive hydraulic pumps are driven by at least one electric drive motor and the amount of electrical energy that can be stored in energy storage units and thus also the range or operating time of a ground processing machine is limited.

If the hydraulic drive system has a simple design, ensuring that both traction drive hydraulic pumps deliver substantially the same amount of fluid to be able to achieve the same rotational speeds on all traction drive hydraulic motors, both traction drive hydraulic pumps can be driven by a common drive motor for delivering hydraulic fluid, or/and both traction drive hydraulic pumps can have the same delivery volume. Furthermore, all traction drive hydraulic motors can have the same displacement volume. The delivery volume of a traction drive hydraulic pump can, for example, be the volume of fluid delivered per revolution of the traction drive hydraulic pump, and the displacement volume of a traction drive hydraulic motor can be the volume of fluid absorbed per revolution of the traction drive hydraulic motor.

To operate a ground processing machine electro-hydraulically, at least one drive motor can be an electric motor.

In particular in electro-hydraulic drive systems, that is, when one or more drive motors are designed as electric motors, it is advantageous to obtain a simply structured hydraulic drive system that each traction drive hydraulic pump is a pump with a fixed delivery volume or/and that each traction drive hydraulic motor is a motor with a fixed displacement volume. This means that, during operation, the traction drive hydraulic pumps or the traction drive hydraulic motors do not have to be adjusted to achieve different rotational speeds and thus also different travel speeds of the ground processing machine. This can be achieved simply by changing the rotational speed of the drive motor(s).

An extended networking of the traction drive hydraulic motors for further improved slip control can be achieved in that:
in association with the second fluid connection of the first traction drive hydraulic motor, a first valve unit is provided for selectively establishing and interrupting a connection of the second fluid connection of the first traction drive hydraulic motor to the third hydraulic line and a second valve unit is provided for selectively establishing and interrupting a connection of the second fluid connection of the first traction drive hydraulic motor to the fourth hydraulic line,

and
in association with the second fluid connection of the second traction drive hydraulic motor, a third valve unit is provided for selectively establishing and interrupting a connection of the second fluid connection of the second traction drive hydraulic motor to the third hydraulic line and a fourth valve unit is provided for selectively establishing and interrupting a connection of the second fluid connection of the second traction drive hydraulic motor to the fourth hydraulic line.

This makes it possible to change the pairings of the traction drive hydraulic motors connected to the same traction drive hydraulic pump on the outflow side depending on the drive roller segment at which slip occurs.

To be able to change the cross-connection of the traction drive hydraulic motors with the traction drive hydraulic pumps in a defined manner depending on the drive roller segments at which slip occurs, a control arrangement for controlling the first valve unit, the second valve unit, the third valve unit and the fourth valve unit can be provided, which is designed to:
when the first valve unit for establishing the connection of the second fluid connection of the first traction drive hydraulic motor to the third hydraulic line and the fourth valve unit for establishing the connection of the second fluid connection of the second traction drive hydraulic motor to the fourth hydraulic line are operated, the second valve unit for interrupting the connection of the second fluid connection of the first traction drive hydraulic motor to the fourth hydraulic line and the third valve unit for interrupting the connection of the second fluid connection of the second traction drive hydraulic motor to the third hydraulic line are operated,

and
when the first valve unit for interrupting the connection of the second fluid connection of the first traction drive hydraulic motor to the third hydraulic line and the fourth valve unit for interrupting the connection of the second fluid connection of the second traction drive hydraulic motor to the fourth hydraulic line are operated, the second valve unit for establishing the connection of the second fluid connection of the first traction drive hydraulic motor to the fourth hydraulic line and the third valve unit for establishing the connection of the second fluid connection of the second traction drive hydraulic motor to the third hydraulic line are operated.

To be able to compensate for fluid leaks, for example in the area of the traction drive hydraulic motors, a fluid feed arrangement can be provided for feeding fluid into at least one fluid line of the first fluid line, second fluid line, third fluid line, and fourth fluid line.

Such a fluid feed arrangement is generally designed to feed fluid on the low-pressure side of a hydraulic circuit, that is, into the hydraulic lines connecting the traction drive hydraulic motors on the outflow side to the traction drive hydraulic pumps, to keep the fluid pressure in the area of these lines at a defined level. In interaction with such a fluid feed arrangement, if slippage occurs on a drive roller segment, the associated traction drive hydraulic motor can briefly operate at a slightly increased rotational speed and thus also with a correspondingly greater fluid outflow. The greater fluid outflow via such a traction drive hydraulic motor can in principle be compensated by a smaller feed of fluid through the fluid feed arrangement, even if the limitation is basically defined by the amount of fluid fed back to the same traction drive hydraulic pump from another traction drive hydraulic motor. Due to this interaction, a reduced drive torque is set at a traction drive hydraulic motor associated with a drive roller segment with traction loss, which corresponds to the maximum drive torque that can be transmitted via this drive roller segment without slip.

A first drive roller of the two drive rollers may comprise the first drive roller segment and the second drive roller segment, and a second drive roller of the two drive rollers may comprise the third drive roller segment and the fourth drive roller segment.

To reduce the probability of a state occurring in which two traction drive hydraulic motors that fundamentally limit each other in terms of the fluid outflow quantity simultaneously enter a slip state by a defined association of the cross-connected traction drive hydraulic motors with the various drive roller segments, it is proposed that, with respect to a machine longitudinal direction, the first drive roller segment and the third drive roller segment are arranged on a first side of the ground processing machine and the second drive roller segment and the fourth drive roller segment are arranged on a second side of the ground processing machine. This association of the traction drive hydraulic motors with the drive roller segments also makes it possible for different rotational speeds to occur on the drive roller segments on the inside and outside of the curve when cornering, without the traction drive hydraulic motors connected to one another on the outflow side blocking one another with the fluid quantities they each deliver.

When a ground processing machine is designed as a ground compactor, at least one drive roller of the two drive rollers can be a ground processing roller, wherein each drive roller segment of the at least one drive roller is provided by a roller segment. Alternatively or additionally, at least one drive roller of the two drive rollers may comprise at least two wheels, wherein each drive roller segment of the at least one drive roller comprises at least one wheel. Such drive wheels can be drive wheels that purely serve to drive the ground processing machine, for example, positioned on both sides of a rear carriage, or can also be, for example, rubber wheels of a rubber-wheeled roller associated with one another in pairs.

To be able to take suitable measures when slip occurs, for example by the defined switching of various valve units, a slip detection arrangement for detecting a slip state of at least one drive roller segment, preferably of each drive roller segment, can be provided.

The slip detection arrangement can comprise a rotational speed sensor in association with at least one drive roller segment, preferably with each drive roller segment.

The present invention is described in detail below with reference to the attached figures. Wherein:

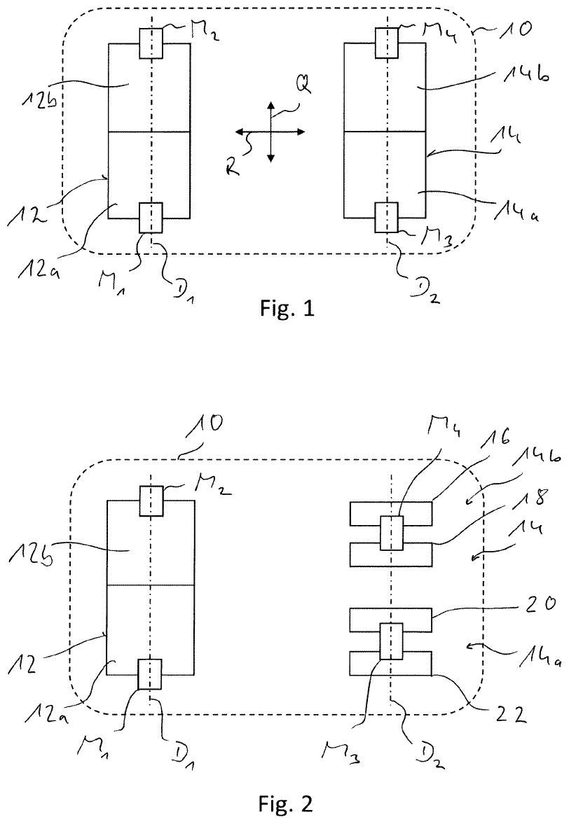

FIG. 1 shows a schematic representation of a ground processing machine designed as a ground compactor having two ground processing rollers;

FIG. 2 shows a schematic representation of an alternative embodiment of a ground processing machine designed as a ground compactor;

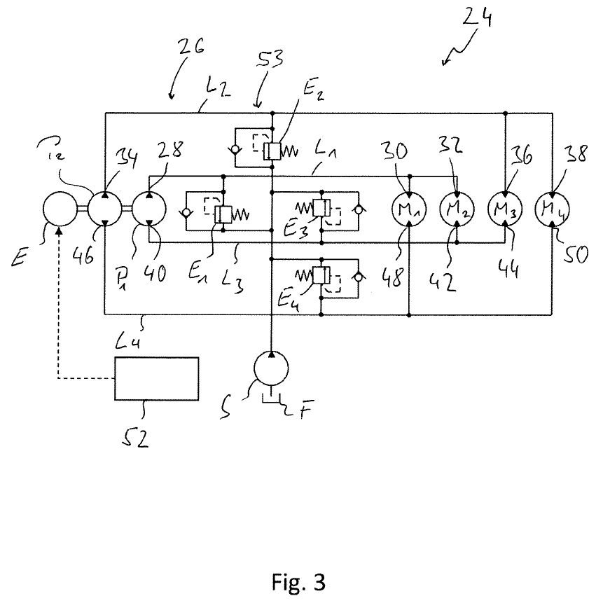

FIG. 3 shows an embodiment of an electro-hydraulic drive system for a ground processing machine;

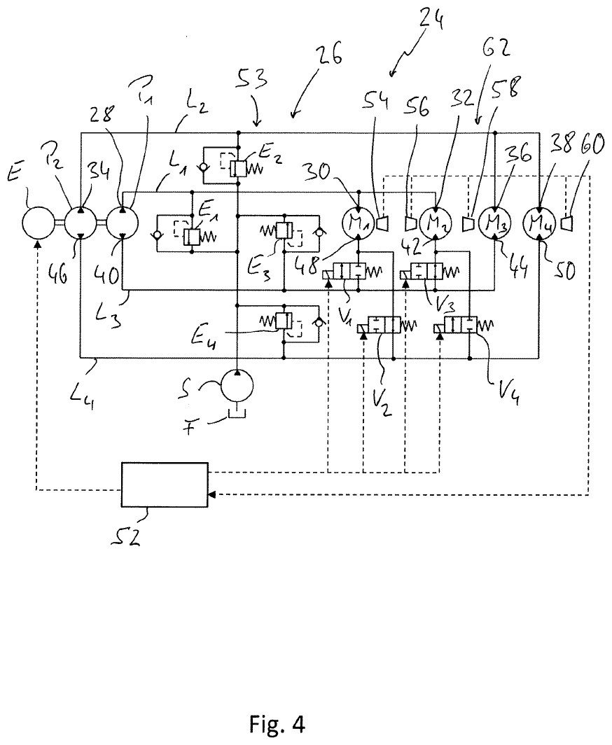

FIG. 4 shows an alternative embodiment of an electro-hydraulic drive system for a ground processing machine.

FIG. 1 shows a schematic representation of a ground processing machine designed as a ground compactor and generally designated by 10. The ground processing machine 10 designed as a ground compactor comprises two drive rollers 12, 14 arranged one after the other in a machine longitudinal direction R thereof and each designed as a ground processing roller. The drive roller 12 is rotatable about a first axis of rotation D₁, and the drive roller 14 is rotatable about a second axis of rotation D₂. Each of the two drive rollers 12, 14 is associated with two traction drive hydraulic motors M₁, M₂ or M₃, M₄. For example, the traction drive hydraulic motors M₁, M₂, M₃, M₄ associated with a respective drive roller 12 or 14 can each be arranged at their axial ends.

The two drive rollers 12, 14 are designed as split ground processing rollers with respective drive roller segments 12a, 12b and 14a, 14b. Each of the drive roller segments 12a, 12b, 14a, 14b is associated with one of the four traction drive hydraulic motors M₁, M₂, M₃, M₄, so that the two drive roller segments 12a, 12b can be driven independently of one another by the traction drive hydraulic motors M₁, M₂ associated with them to rotate about the axis of rotation D₁, and the two drive roller segments 14a, 14b can be driven independently of one another by the traction drive hydraulic motors M₃, M₄ associated with them to rotate about the axis of rotation D₂.

FIG. 2 shows an alternative embodiment of such a ground processing machine 10, for example designed as a ground processing roller. The ground processing machine 10 of FIG. 2 comprises in one of its longitudinal end regions the drive roller 12 designed as a ground processing roller with the two traction drive hydraulic motors M₁, M₂ associated therewith. In this embodiment, the drive roller 12 also comprises two drive roller segments 12a, 12b which can be driven independently of one another by a respective associated traction drive hydraulic motor M₁, M₂ for rotation about the axis of rotation D₁. In the other longitudinal end region of the ground processing machine 10, the drive roller 14 comprises wheels 16, 18, 20, 22. These can be associated with one another in pairs, for example, and each pair of wheels 16, 18 or 20, 22 forms a drive roller segment 14a, 14b, which can be driven by the traction drive hydraulic motor M₃ or M₄ associated therewith for rotation about the axis of rotation D₂.

It should also be noted that other embodiments of such ground processing machines can be applied in the context of a hydraulic drive system described hereinafter. For example, in the case of a ground processing machine designed as a ground compactor, a pair of drive wheels, each forming a drive roller segment of a drive roller, can be provided on a rear carriage, while a ground processing roller divided into roller segments can act as a drive roller on the front carriage. The principles of the present invention can be applied to pivot-steered ground processing machines or ground compactors as well as to ground processing machines divided into front and rear carriages.

FIG. 3 shows a hydraulic drive system 24, which in the illustrated embodiment is an electro-hydraulic drive system and can be used, for example, in conjunction with the ground processing machines described above with reference to FIGS. 1 and 2.

The hydraulic drive system 24 comprises two traction drive hydraulic pumps P₁, P₂ and the four traction drive hydraulic motors M₁, M₂, M₃, M₄ in a hydraulic circuit 26. The two traction drive hydraulic pumps P₁, P₂ can be driven jointly by a drive motor E designed as an electric motor.

A first fluid connection 28 of the first traction drive hydraulic pump P₁ is connected via a first hydraulic line L₁ to a first fluid connection 30 of the first traction drive hydraulic motor M₁ and a first fluid connection 32 of the second traction drive hydraulic motor M₂. A first fluid connection 34 of the second traction drive hydraulic pump P₂ is connected via a second hydraulic line L₂ to a first fluid connection 36 of the third traction drive hydraulic motor M₃ and a first fluid connection 38 of the fourth traction drive hydraulic motor M₄.

A second fluid connection 40 of the first traction drive hydraulic pump P₁ is connected via a third fluid line L₃ to a second fluid connection 42 of the second traction drive hydraulic motor M₂ and a second fluid connection 44 of the third traction drive hydraulic motor M₃. A second fluid connection 46 of the second traction drive hydraulic pump P₂ is connected via a fourth fluid line L₄ to a second fluid connection 48 of the first traction drive hydraulic motor M₁ and a second fluid connection 50 of the fourth traction drive hydraulic motor M₄.

Depending on the direction in which the ground processing machine 10 is to be moved, for example when driving forward, the drive motor E can be controlled by a control unit 52 for operating the traction drive hydraulic pumps P₁, P₂ in such a conveying direction that they feed fluid at their respective first fluid connections 28, 34 into the first hydraulic line L₁ or the second hydraulic line L₂ and therefore feed the fluid under high pressure, for example hydraulic oil, via the respective first fluid connections 30, 32, 36, 38 into the traction drive hydraulic motors M₁, M₂, M₃, M₄.

In this state, the traction drive hydraulic motors M₁, M₂, M₃, M₄ release the fluid under significantly reduced pressure at their respective second fluid connections 48, 42, 44, 50 into the third hydraulic line L₃ or the fourth hydraulic line L₄, via which the fluid flows back to the second fluid connections 40, 46 of the traction drive hydraulic pumps P₁, P₂.

If the ground processing machine 10 is to be moved in the opposite direction, for example in reverse, the drive motor E is controlled such that the traction drive hydraulic pumps P₁, P₂ driven by it release the fluid via their respective second fluid connections 40, 46 into the third hydraulic line L₃ or the fourth hydraulic line L₄. The fluid delivered by the first traction drive hydraulic pump P₁ flows via the third hydraulic line L₃ to the second fluid connections 42, 44 of the second traction drive hydraulic motor M₂ and the third traction drive hydraulic motor M₃. The fluid delivered by the second traction drive hydraulic pump P₂ flows via the fourth hydraulic line L₄ to the second fluid connections 48, 50 of the first traction drive hydraulic motor M₁ and the fourth traction drive hydraulic motor M₄, respectively. In this operating state, the first traction drive hydraulic motor M₁ and the second traction drive hydraulic motor M₂ deliver fluid at their first fluid connections 30, 32 via the first hydraulic line L₁ to the first fluid connection 28 of the first traction drive hydraulic pump 28, and the third traction drive hydraulic motor M₃ and the fourth traction drive hydraulic motor M₄ deliver fluid at their first fluid connections 36, 38 via the second fluid line L₂ to the first fluid connection 34 of the second traction drive hydraulic pump P₂.

By means of a feed arrangement generally designated 53, fluid leaks occurring in particular in the area of the traction drive hydraulic motors M₁, M₂, M₃, M₄ can be compensated by feeding fluid onto the low-pressure side of the hydraulic circuit 26. For this purpose, the feed arrangement 54 comprises a feed pump S, which is driven, for example, by a drive motor associated therewith, which pump draws fluid from a fluid reservoir F and feeds it via four feed valves E₁, E₂, E₃, E₄ into the first hydraulic line L₁, the second hydraulic line L₂, the third hydraulic line L₃, and the fourth hydraulic line L₄, respectively.

In the hydraulic drive system 24 shown in FIG. 2, regardless of the direction in which the ground processing machine 10 is moved or the direction in which the traction drive hydraulic motors M₁, M₂, M₃, M₄ associated with the various drive roller segments 12a, 12b, 14a, 14b rotate, two traction drive hydraulic motors are each connected on the high-pressure side, that is, on the inflow side, to the same traction drive hydraulic pump P₁ or P₂. When fluid is delivered via the respective first fluid connections 28, 34 of the traction drive hydraulic pumps P₁, P₂, the traction drive hydraulic motors M₁, M₂ are connected on the high-pressure side to the first traction drive hydraulic pump 28 and the traction drive hydraulic motors M₃, M₄ are connected on the high-pressure side to the second traction drive hydraulic pump P₂.

However, on the low-pressure side, that is, the outflow side, the traction drive hydraulic motors that are also connected to one of the traction drive hydraulic pumps on the high-pressure side are not also connected to the same traction drive hydraulic pump. Only one of the traction drive hydraulic motors connected to a traction drive hydraulic pump on the high-pressure side is also connected to this traction drive hydraulic pump on the low-pressure side, while the other traction drive hydraulic motor is connected to the other traction drive hydraulic pump on the low-pressure side. In the illustrated embodiment, this means that, when fluid is delivered via the first fluid connections 28, 34 of the traction drive hydraulic pumps P₁, P₂, the second traction drive hydraulic motor M₂ and the third traction drive hydraulic motor M₃ are connected to the first traction drive hydraulic pump P₁ via the third hydraulic line M₃, while the first traction drive hydraulic motor M₁ and the fourth traction drive hydraulic motor M₄ are connected to the second traction drive hydraulic pump P₂ via the fourth hydraulic line M₄.

When moving in the opposite direction, that is, when fluid is released via the respective second fluid connections 40, 46 of the traction drive hydraulic pump P₁, P₂, the second traction drive hydraulic motor M₂ and the third traction drive hydraulic motor M₃ are connected to the first traction drive hydraulic pump 28 on the high-pressure side, that is, via the third hydraulic line L₃, while the first traction drive hydraulic motor M₁ and the fourth traction drive hydraulic motor M₄ are connected to the second traction drive hydraulic pump P₂ via the fourth hydraulic line L₄. In this state, on the low-pressure side, the first traction drive hydraulic motor M₁ and the second traction drive hydraulic motor M₂ are connected to the first traction drive hydraulic pump P₁ via the first hydraulic line L₁, while the third traction drive hydraulic motor M₃ and the fourth traction drive hydraulic motor M₄ are connected to the second traction drive hydraulic pump P₂ via the second hydraulic line L₂.

Since in such a hydraulic drive system 24 each of the traction drive hydraulic pumps P₁, P₂ can only take in as much fluid on the low-pressure side as it delivers on the high-pressure side during delivery operation, it is important that in this cross-connection of the traction drive hydraulic motors M₁, M₂, M₃, M₄ with the traction drive hydraulic pumps P₁, P₂, each of the traction drive hydraulic pumps P₁, P₂ delivers substantially the same amount of fluid and each of the traction drive hydraulic motors M₁, M₂, M₃, M₄ takes in substantially the same amount of fluid. In particular, when designed as an electro-hydraulic drive system, it is advantageous if the traction drive hydraulic pumps P₁, P₂ have a constant delivery volume and the traction drive hydraulic motors M₁, M₂, M₃, M₄ have a constant displacement volume. Changes in the delivery rate can be generated solely by changing the rotational speed of the drive motor E, which is designed as an electric motor. With such a design of the traction drive hydraulic pumps P₁, P₂ and traction drive hydraulic motors M₁, M₂, M₃, M₄, each having the same delivery volume or displacement volume, all traction drive hydraulic motors M₁, M₂, M₃, M₄ rotate at the same rotational speed or drive the drive roller segments 12a, 12b, 14a, 14b associated with them to rotate at the same rotational speed. This in turn requires that all drive roller segments 12a, 12b, 14a, 14b have the same diameter. If the drive rollers 12, 14 provided in association with the various axes of rotation D1, D2 have different diameters, traction drive hydraulic motors with different displacement volumes can be used for the drive roller segments 12a, 12b on the one hand and the drive roller segments 14a, 14b on the other hand in the association of the traction drive hydraulic motors M₁, M₂, M₃, M₄ with the drive roller segments 12a, 12b, 14a, 14b, as shown in particular in FIGS. 1 and 2.

The cross-connection of the traction drive hydraulic motors M₁, M₂, M₃, M₄ ensures that none of the drive roller segments 12a, 12b, 14a, 14b can enter a slip state in which an excessively large amount of fluid flows out of the associated traction drive hydraulic motor due to an increase in rotational speed of the motor. If, for example, slippage were to occur on the first drive roller segment 12a due to a loss of traction, this would result in the drive hydraulic motor M₁ taking in and accordingly releasing a larger quantity of fluid due to a correspondingly higher rotational speed. Since the first traction drive hydraulic motor M₁, in a state in which it receives fluid from the first traction drive hydraulic pump P₁ via the first hydraulic line L₁, for example, releases the absorbed fluid into the fourth fluid line L₄, and since the fourth traction drive hydraulic motor M₄ fed by the other traction drive hydraulic pump P₂ releases the amount of fluid corresponding to normal traction into the fourth hydraulic line L₄ in this state, the fourth hydraulic line La can only absorb the amount of fluid that it would basically also release in a slip-free state from the first traction drive hydraulic motor M₁. The first traction drive hydraulic motor M₁ could therefore in principle not rotate faster than the other traction drive hydraulic motors M₂, M₃, M₄, even in the event of a loss of traction of the associated first drive roller segment 12a, and therefore also not lead to an excessive outflow of fluid from the first hydraulic line L₁.

However, due to the fluid leaks mentioned above, there is basically the possibility that the first drive hydraulic motor M₁ briefly releases a larger amount of fluid when a loss of traction occurs at the associated first drive roller segment 12a than would be the case in the non-slipping state. This larger amount of fluid fed into the fourth hydraulic line L₄ via the first traction drive hydraulic motor M₁ then does not have to be replenished by the feed arrangement 53 to maintain the defined pressure on the low-pressure side of the hydraulic circuit 26.

Such a short-term slip-related increase in rotational speed of the first drive hydraulic motor M₁ leads to a spontaneous drop in pressure on the high-pressure side, in this case in the first hydraulic line L₁. This pressure drop results in a decrease of the drive torque generated at the first drive hydraulic motor to such a value that the first drive roller segment 12a, which has lower traction, is again operated without slip. This decrease in the drive torque at the first traction drive hydraulic motor M₁ also leads to a corresponding decrease in the drive torque of the second traction drive hydraulic motor M₂, which is subjected to the same pressure. Since the drive power of the drive motor E is basically maintained, a correspondingly higher pressure is created in the second hydraulic line L₂ fed from the second drive hydraulic pump P₂, so that the drive hydraulic motors M₃, M₄ fed from the second hydraulic line L₂ are operated at a correspondingly increased drive torque.

The previously described independent adjustment of the drive torque or the rotational speed of a drive roller segment when a loss of traction occurs is independent of which of the drive roller segments the loss of traction occurs on and in which direction the ground processing machine 10 is moved. Due to the connection on the outflow side of each traction drive hydraulic motor M₁, M₂, M₃, M₄ with another traction drive hydraulic motor which is not fed from the same traction drive hydraulic pump, the traction drive hydraulic motors block each other against a slip-related increase in rotational speed.

Despite this mutual blocking of the drive hydraulic motors M₁, M₂, M₃, M₄ which are linked to one another on the outflow side, there is the possibility, particularly in the case of association of the drive hydraulic motors M₁, M₂, M₃, M₄ to the drive roller segments 12a, 12b, 14a, 14b as shown in FIGS. 1, 2 and 3, that when cornering, the respective inner pair of drive roller segments 12a, 14a or 12b, 14b rotates at a lower rotational speed than the respective outer pair of drive roller segments 12a, 14a or 12b, 14b. A lower fluid outflow of the first traction drive hydraulic motor M₁ caused, for example, by a lower rotational speed of the drive roller segment 12a is compensated by a correspondingly increased fluid outflow of the fourth traction drive hydraulic motor M₄, such that their joint fluid outflow again corresponds to the sum of the fluid outflow quantities of these two traction drive hydraulic motors M₁, M₄ at the same rotational speed. The same applies to the traction drive hydraulic motors M₂, M₃ or to any pairing of traction drive hydraulic motors linked together on the outflow side when moving in the other direction of travel.

FIG. 4 shows an embodiment of the hydraulic drive system 24 in which the probability of a slip condition occurring on one of the drive roller segments 12a, 12b, 14a, 14b is further reduced. It can be seen in FIG. 4 that, for example, two valve units V₁, V₂ and V₃, V₄ are provided in association with the first traction drive hydraulic motor M₁ and in association with the second traction drive hydraulic motor M₂. The second fluid connection 48 of the first traction drive hydraulic motor M₁ can be optionally connected to or separated from the third hydraulic line L₃ by the first valve unit V₁. The second fluid connection 48 of the first traction drive hydraulic motor M₁ can be optionally connected to or separated from the fourth hydraulic line L₄ by the second valve unit V₂.

The valve units V₁, V₂ controlled by the control unit 52 are basically controlled in such a way that when one of the valve units V₁, V₂ establishes a connection of the second fluid connection 48 of the first traction drive hydraulic motor M₁, the other valve unit interrupts the connection with the associated hydraulic line. The second fluid connection 48 of the first traction drive hydraulic motor M₁ is therefore either in connection with the third fluid line L₃ or in connection with the fourth fluid line L₄.

The third valve unit V₃ associated with the second traction drive hydraulic motor M₂ optionally establishes a connection of the second fluid connection 42 with the third hydraulic line L₃ or interrupts it. Likewise, the fourth valve unit V₄ optionally establishes a connection between the second fluid connection 42 of the second traction drive hydraulic motor M₂ and the fourth fluid line M₄ or interrupts it. The two valve units V₃, V₄ are also controlled by the control unit 52 in such a way that when one of the valve units establishes the connection with the associated hydraulic line, the other valve unit is in its interrupted state.

Furthermore, the four valve units V₁, V₂, V₃, V₄ are controlled or operated by the control unit 52 such that a state in which the two second outlet connections 48, 42 of the traction drive hydraulic motors M₁, M₂ are in connection with the same hydraulic line L₃ or L₄ does not occur. When the second fluid connection 48 of the first traction drive hydraulic motor M₃, as shown in FIG. 3, is in communication with the fourth hydraulic line L₄, the second fluid connection 42 of the second traction drive hydraulic motor M₂ is in communication with the third fluid line L₃, and vice versa.

The switching state of the valve units V₁, V₂, V₃, V₄ shown in FIG. 4 thus basically corresponds to the connection state that is unchangeably present in FIG. 3, in which the second fluid connection 48 of the first traction drive hydraulic motor M₁ is in connection with the fourth hydraulic line L₄ and the second fluid connection 42 of the second traction drive hydraulic motor M₂ is in connection with the third fluid line L₃.

If, in such a state, a loss of traction were to occur at the two drive roller segments 12a, 14a or 12b, 14b positioned on the same side of the ground compactor 10 with respect to the machine longitudinal direction R, that is, on the same side in the machine transverse direction Q, a fluid short circuit can occur in the hydraulic circuit 26, in which the entire fluid delivered by the traction drive hydraulic pumps P₁, P₂ flows away via the traction drive hydraulic motors associated with the slipping drive roller segments, while no fluid flows via the traction drive hydraulic motors associated with the non-slipping drive roller segments.

To counteract this problem, in the hydraulic drive system 26 shown in FIG. 4, rotational speed sensors 54, 56, 58, 60 of a slip detection arrangement 62 are provided in association with the traction drive hydraulic motors M₁, M₂, M₃, M₄. The rotational speed signal emitted by the rotational speed sensors 54, 56, 58, 60 provides the control unit 52 with information about which of the drive roller segments 12a, 14a, 12b, 14b is experiencing a loss of traction.

If, for example, a loss of traction with corresponding slip occurs simultaneously at the drive roller segments 12b, 14b, which in the switching state shown in FIG. 3 would result in all of the fluid fed into the second hydraulic line L₂ flowing out via the fourth traction drive hydraulic motor M₄ and all of the fluid fed into the first hydraulic line L₁ flowing out via the second traction drive hydraulic motor M₂, the four valve units V₁, V₂, V₃, V₄ can be switched starting from the switching state shown in FIG. 3, such that the first traction drive hydraulic motor M₁ is then coupled on the outflow side to the third hydraulic line L₃, while the second traction drive hydraulic motor M₂ is coupled on the outflow side to the fourth hydraulic line L₄. In this state, the two drive hydraulic motors M₂, M₄, which are associated with the drive roller segments 12b, 14b having a loss of traction, are then linked to one another on the outflow side, such that again due to the fact that the second drive hydraulic pump P₂ can only take up a defined amount of fluid at its second fluid connection 46, the amount of fluid flowing out via these drive hydraulic motors M₂, M₄ is again substantially limited to the amount of fluid that flows through them even in the non-slipping state.

It should be noted that, in an alternative embodiment, the variability introduced by the valve units V₁, V₂, V₃, V₄ could also be achieved if these were provided in conjunction with the traction drive motors M₃, Ma and the hydraulic lines L₃, L₄ or if these were provided in conjunction with the traction drive hydraulic motors M₂ and M₃ or in conjunction with the traction drive hydraulic motors M₁, M₄, each in association with the first hydraulic line L₁ and the second hydraulic line L₂.

1. A ground processing machine having two drive rollers arranged one after the other in a machine longitudinal direction and rotatable about a respective axis of rotation, wherein each drive roller comprises two drive roller segments arranged one after the other in the direction of the associated axis of rotation, and having a hydraulic drive system for the drive rollers, wherein the hydraulic drive system comprises:
in association with a first drive roller segment of the two drive rollers, a first traction drive hydraulic motor,
in association with a second drive roller segment of the two drive rollers, a second traction drive hydraulic motor,
in association with a third drive roller segment of the two drive rollers, a third traction drive hydraulic motor,
in association with a fourth drive roller segment of the two drive rollers, a fourth traction drive hydraulic motor,
a first traction drive hydraulic pump,
a second traction drive hydraulic pump,
at least one drive motor for driving the first traction drive hydraulic pump and the second traction drive hydraulic pump for supplying hydraulic fluid to the traction drive hydraulic motors,
wherein:
a first fluid connection of the first traction drive hydraulic pump is connected or connectable by means of a first hydraulic line to a first fluid connection of the first traction drive hydraulic motor and a first fluid connection of the second traction drive hydraulic motor,
a first fluid connection of the second traction drive hydraulic pump is connected or connectable by means of a second hydraulic line to a first fluid connection of the third traction drive hydraulic motor and a first fluid connection of the fourth traction drive hydraulic motor,
a second fluid connection of the first traction drive hydraulic pump is connected or connectable by means of a third hydraulic line to a second fluid connection of the second traction drive hydraulic motor and a second fluid connection of the third traction drive hydraulic motor,
a second fluid connection of the second traction drive hydraulic pump is connected or connectable by means of a fourth hydraulic line to a second fluid connection of the first traction drive hydraulic motor and a second fluid connection of the fourth traction drive hydraulic motor.

2. The ground processing machine of claim 1,
wherein both traction drive hydraulic pumps are driven by a common drive motor for pumping hydraulic fluid, or/and in that both traction drive hydraulic pumps have the same delivery volume, or/and in that all traction drive hydraulic motors have the same displacement volume.

3. The ground processing machine of claim 1,
wherein the at least one drive motor (E) is an electric motor.

4. The ground processing machine of claim 1,
wherein each traction drive hydraulic pump is a pump with a fixed delivery volume, or/and in that each traction drive hydraulic motor is a motor with a fixed displacement volume.

5. The ground processing machine of claim 1,
wherein:
in association with the second fluid connection of the first traction drive hydraulic motor, a first valve unit is provided for selectively establishing and interrupting a connection of the second fluid connection of the first traction drive hydraulic motor to the third hydraulic line and a second valve unit is provided for selectively establishing and interrupting a connection of the second fluid connection of the first traction drive hydraulic motor to the fourth hydraulic line,
and
in association with the second fluid connection of the second traction drive hydraulic motor, a third valve unit is provided for selectively establishing and interrupting a connection of the second fluid connection of the second traction drive hydraulic motor to the third hydraulic line and a fourth valve unit is provided for selectively establishing and interrupting a connection of the second fluid connection of the second traction drive hydraulic motor to the fourth hydraulic line.

6. The ground processing machine of claim 5,
wherein a control arrangement is provided for controlling the first valve unit, the second valve unit, the third valve unit and the fourth valve unit, wherein the control unit is designed to:
when the first valve unit for establishing the connection of the second fluid connection of the first traction drive hydraulic motor to the third hydraulic line and the fourth valve unit for establishing the connection of the second fluid connection of the second traction drive hydraulic motor to the fourth hydraulic line are operated, the second valve unit for interrupting the connection of the second fluid connection of the first traction drive hydraulic motor to the fourth hydraulic line and the third valve unit for interrupting the connection of the second fluid connection of the second traction drive hydraulic motor to the third hydraulic line are operated,
and
when the first valve unit for interrupting the connection of the second fluid connection of the first traction drive hydraulic motor to the third hydraulic line and the fourth valve unit for interrupting the connection of the second fluid connection of the second traction drive hydraulic motor to the fourth hydraulic line are operated, the second valve unit for establishing the connection of the second fluid connection of the first traction drive hydraulic motor to the fourth hydraulic line and the third valve unit for establishing the connection of the second fluid connection of the second traction drive hydraulic motor to the third hydraulic line are operated.

7. The ground processing machine according to claim 1,
wherein a fluid feed arrangement is provided for feeding fluid into at least one fluid line of the first fluid line, second fluid line, third fluid line, and fourth fluid line.

8. The ground processing machine according to claim 1,
wherein a first drive roller of the two drive rollers comprises the first drive roller segment and the second drive roller segment and a second drive roller of the two drive rollers comprises the third drive roller segment and the fourth drive roller segment.

9. The ground processing machine of claim 8,
wherein, relative to a machine longitudinal direction, the first drive roller segment and the third drive roller segment are arranged on a first side of the ground processing machine and the second drive roller segment and the fourth drive roller segment are arranged on a second side of the ground processing machine.

10. The ground processing machine of claim 1,
wherein at least one drive roller of the two drive rollers is a ground processing roller, wherein each drive roller segment of the at least one drive roller is provided by a roller segment, or/and in that at least one drive roller of the two drive rollers comprises at least two wheels, wherein each drive roller segment of the at least one drive roller comprises at least one wheel.

11. The ground processing machine of claim 1,
wherein a slip detection arrangement is provided for detecting a slip state of at least one drive roller segment.

12. The ground processing machine of claim 11,
wherein the slip detection arrangement comprises a rotational speed sensor in association with at least one drive roller segment.
